(19) United States
(12) Patent Application Publication
(10) Pub. No.: US 2015/0175258 A1
(43) Pub. Date: Jun. 25, 2015

(54) HELICOPTER WITH H-PATTERN STRUCTURE

(71) Applicant: Hung-Fu LEE, New Taipei City (TW)

(72) Inventor: Hung-Fu LEE, New Taipei City (TW)

(21) Appl. No.: 14/137,052

(22) Filed: Dec. 20, 2013

(51) Int. Cl. B64C 27/08; B64D 17/80

(52) U.S. Cl. CPC B64C 27/08; B64D 17/80

(57) ABSTRACT

A helicopter with an H-pattern structure is provided. With an H-pattern transmission mechanism operating in collaboration with two pairs of rotor sets, which are disposed at two sides of a front region and a rear region of an airframe and being rotated in opposite directions, torques generated by the two pairs of rotor sets being rotated in opposite directions are counteracted. Thus, a flight posture and rotation direction during a flight of the helicopter is kept balanced, and at the same time, the helicopter is provided with a simple structure and ensured flight safety.

### BACKGROUND OF THE INVENTION

A) Field of the Invention

The invention relates in general to a helicopter with an H-pattern structure, and more particularly to a helicopter that has a simple mechanical structure and is capable of maintaining flight balance as well as controlling a flight posture and rotation direction for ensuring flight safety.

b) Description of the Prior Art

Helicopters have long been one of the most convenient air transportation means and essential air forces. The prominence of helicopters is contributed by the vertical ascending and vertical descending capabilities without involving approach tracks. However, helicopters are also set back by severe restrictions derived from principles of flight of helicopters.

In a conventional helicopter, a main rotor and a tail rotor that have orthogonally staggered axial centers are propelled by a same engine power. The main rotor controls the ascending and descending as well as forward, backward, left and right movements of the helicopter, whereas the tail rotor assists the left and right movements of the helicopter.

When a conventional helicopter is to perform a forward flight, a pilot shifts a control lever forward to increase a rear power angle of the main rotor, so that the helicopter is propelled forward by the larger airflow that is generated behind the main rotor and greater than the airflow in the front. Conversely, to perform a backward flight, the pilot shifts the control lever backward to increase a front power angle of the main rotor to thus enable the helicopter to fly backward.

Although the helicopter is a convenient air transportation means, in order to at the same time provide effects of tilting forward and backward as well as left and right and thus allowing the helicopter to freely fly in the sky, the main rotor of the helicopter has an extremely complex design. Moreover, the structure of the tail rotor is also complex for it needs to provide a high thrust at one moment and a low thrust at another.

The main rotor and rear rotor of a conventional helicopter are designed with sophisticated structures in a way that piloting such helicopter is made quite challenging. Further, such helicopter is prone to unbalanced flights, and the flight speed is also limited by the main rotor. In addition to powering the main rotor, an engine needs to allocate 20% of its engine power to the tail rotor in order to achieve the balance in the helicopter instead utilizing that power to boost the ascending force. Further, due to the provision of the main rotor, neither injection seats nor parachutes can be installed on the helicopter, meaning that the helicopter is fated for an inevitable crash in the event of a machinery malfunction and hence pilot casualties. Although the helicopter is designed with an auto rotation function, such flying technique requires tens to hundreds of hours of professional training and offers no 100% guarantee of safety.

In view of the above, the Applicant has been issued with a patent, “Dual Power Helicopter without Tail Rotor”, in Taiwan and the US, respectively numbered Taiwan Patent No. I299721 and U.S. Pat. No. 7,546,976. In the above patent, the flight of the helicopter is mainly controlled by two power devices rotated in opposite directions. The two power devices are rotated in the opposite directions by steering gears from a same engine, such that the engine power can be completely transmitted to the two power devices, enabling the engine power to be completely developed, thereby improving performance of the helicopter.

### SUMMARY OF THE INVENTION

The invention is directed to a helicopter with an H-pattern structure, more particularly to a helicopter that has a simple mechanical structure and is capable of maintaining flight balance as well as controlling a flight posture and rotation direction, thereby enhancing the safety and operations as well as increasing the flying speed of the helicopter.

To achieve the above objects, a helicopter with an H-pattern structure is provided by the present invention. In the present invention, with an H-pattern transmission mechanism operating in collaboration with two pairs of rotor sets, which are disposed at two sides of a front region and a rear region of an airframe and being rotated in opposite directions, torques generated by the two pairs of rotor sets being rotated in the opposite directions are counteracted. Thus, a flight posture and rotation direction during a flight of the helicopter is kept balanced, and at the same time, the helicopter is provided with a simple structure and ensured flight safety.

Each of the pairs of rotor sets is formed by, two rotor sets. Each rotor set includes a gear box, a power angle control module, a linear servo motor and at least one propeller. The gear boxes are connected to the H-pattern transmission mechanism.

The H-pattern transmission mechanism includes an engine, a set of transmission mechanism, two deceleration gear boxes and a plurality of transmission shafts. The transmission mechanism includes a main transmitting wheel and a transmitted wheel. The main transmitting wheel is connected to the engine, and the transmitted wheel is connected to the two deceleration gear boxes by one transmission shaft. The two deceleration gear boxes are connected to the gear boxes of each of the rotor sets, thereby evenly transmitting the power outputted from the engine to each of the rotor sets.

The helicopter with an H-pattern structure of the present invention further includes a control device. The control device is connected to the power angle control module of each of the rotor sets, and includes a control lever, a flight control system, a pair of pedals and a power configuration lever. The control lever is connected to the power angle control module of each of the rotor sets, and controls a difference in the power angle of each of the rotor sets. The flight control system collects and calculates various flight data, so as to drive the linear servo motor of each of the rotor sets and to further independently control each of the rotor sets. The pedals serve for controlling the difference between the power angles of every two diagonal rotors. The force configuration lever simultaneously controls the power angles of the four rotor sets. As such, the power angle of each of the rotor set is independently controlled by the control device, enabling the control device to control operations of the helicopter.

Further, the airframe may be designed as a boat shape, which allows the helicopter to safely float on the sea in the event of a power loss of the helicopter.

The two pairs of rotor sets include a pair of front rotors and a pair of rear rotors. The front rotor sets are disposed at left and right sides of the front region, and the rear rotor sets are disposed at left and right sides of the rear region, with a distance between the front rotor sets being greater than a distance between the rear rotor sets.

Further, the propeller of each of the rotor sets includes a body, an adjustment screw, a weight block, and elastic element and a cladding layer. The adjustment screw is disposed at an interior of the body, and has one end formed as an adjustment portion extending to an exterior of the body and the other end accommodated in the elastic member. The weight block is screwed to the adjustment screw. The cladding layer covers the exterior of the body such that the adjustment portion is revealed on the cladding layer. Thus, each propeller is allowed to be adjusted and calibrated to achieve dynamic balance.

Further, a parachute is installed to an upper part of the front region of the airframe. In the event of a power loss of the rotor sets, the parachute enables the helicopter with a safe landing and offers safety measures for passengers and the helicopter. In an emergency, by merely injecting and opening the parachute, the entire helicopter can be decelerated flow a slow landing instead of experiencing a crash. Further, a landing location of the helicopter may be controlled by an oval-shaped parachute.

The above and other aspects of the invention will become better understood with regard to the following detailed description of the preferred but non-limiting embodiments. The following description is made with reference to the accompanying drawings.

### BRIEF DESCRIPTION OF THE DRAWINGS

FIG. 1 is a schematic view of the present invention;

FIG. 2 is a schematic diagram of a rotor set of the present invention;

FIG. 3 is a top view of the present invention;

FIG. 4 is a schematic diagram of an H-shaped transmission mechanism of the present invention;

FIG. 5 is a schematic diagram of a control device of the present invention;

FIG. 5A is an enlarged partial view of FIG. 5;

FIG. 6 is a schematic diagram of the present invention utilizing a parachute;

FIG. 7 is an enlarged partial view of a propeller of the present invention;

FIG. 8 is a schematic diagram of adjusting a weight proportion of a propeller of the present invention; and

FIG. 9 is a schematic diagram of the present invention landing on the sea.

### DETAILED DESCRIPTION OF THE INVENTION

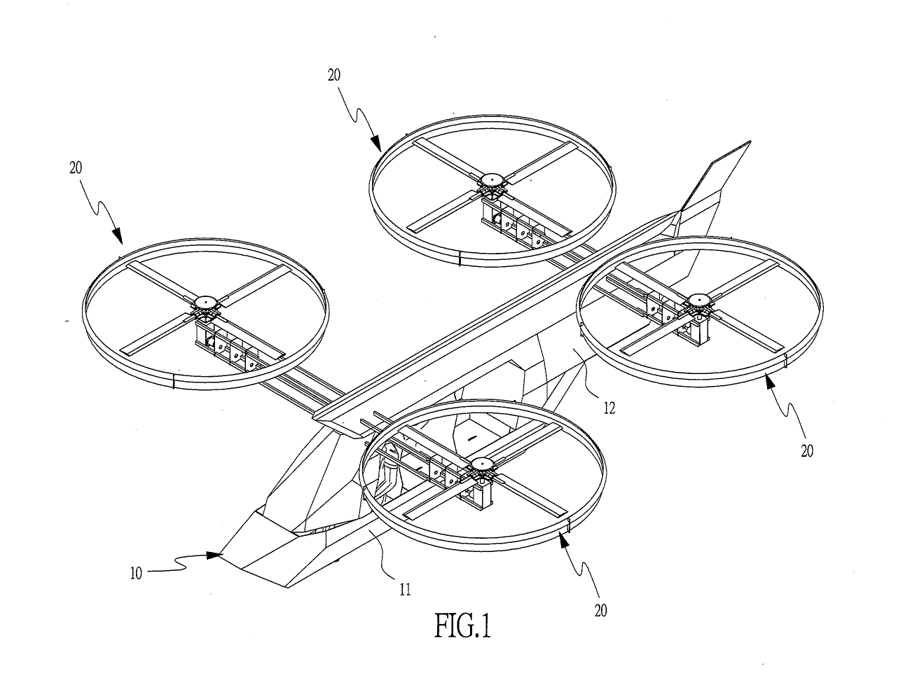

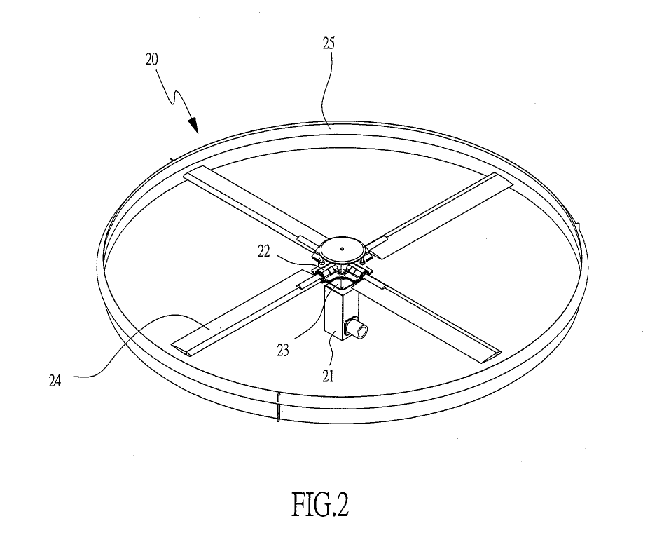

Referring to FIGS. 1 and 2, a helicopter with an H-pattern structure of the present invention includes an airframe 10, four rotor sets 20, an H-pattern transmission mechanism (to be described shortly), and a control device (to be described shortly).

The airframe 10 includes a front region 11 and a rear region 12. The front region 11 is internally provided with a cockpit for carrying a passenger and providing operations of the helicopter. The rear region 12 is an extension from the rear of the front region 11.

The four rotor sets 20 are paired, i.e., two front rotor sets are paired and two rear rotor sets are paired, to form a pair of front rotor sets and a pair of rear rotor sets. Each of the rotor sets 20 includes a gear box 21, a power angle control module 22, a linear servo motor 23, at least one propeller 24, and a windshield 25. The gear box 21 is connected to the H-pattern transmission mechanism. The power angle control module 22 drives the linear servo motor 23 to adjust the power angle of each propeller 24 via the linear servo motor 23. The windshield 25 encircles outside the rotation radius of the propeller 24.

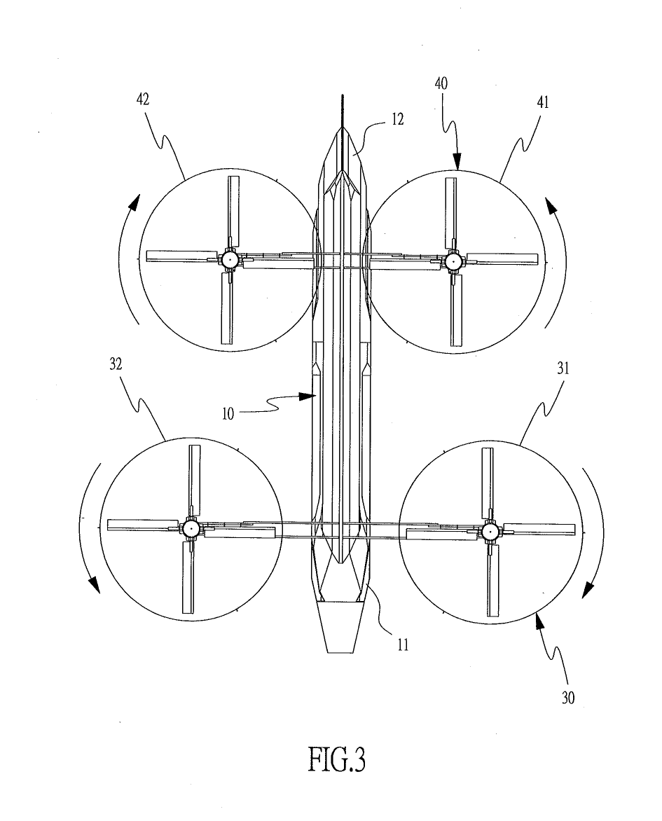

Referring to FIG. 3, the pair of front rotor sets 30 includes a front left rotor set 31 and a front right rotor set 32. The front left rotor set 31 and the front right rotor set 32 are respectively disposed at left and right sides of the front region 11 of the airframe 10. Further, the front left rotor set 31 and the front right rotor set 32 correspond to each other and are rotated in opposite directions.

The pair of rear rotor sets 40 includes a rear left rotor set 41 and a rear right rotor set 42. The rear left rotor set 41 and the rear right rotor set 42 are respectively disposed at left and right sides of the rear region 12 of the airframe 10. Further, the rear left rotor set 41 and the rear right rotor set 42 correspond to each other and are rotated in opposite directions. A distance between the pair of front rotor sets 30 is greater than a distance between the pair of rear rotor sets 40.

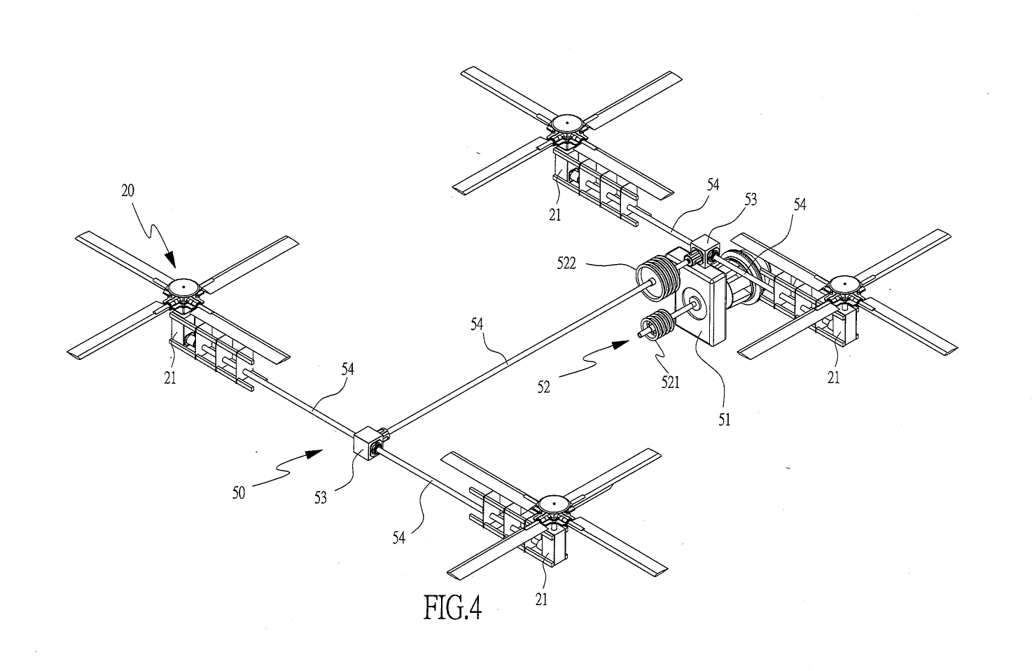

As shown in FIG. 4, an H-pattern transmission mechanism 50 is disposed in the foregoing airframe, and includes, an engine 51, a set of transmission wheels 52, two deceleration gear boxes 53, and a plurality of transmission shafts 54. The transmission wheels 52 include a main transmitting wheel 521 and a transmitted wheel 522. In the embodiment, the main transmitting wheel 521 and the transmitted wheel 522 are exemplified by pulleys, i.e., the main transmitting wheel 521 and the transmitted wheel 522 are linked and transmitted by a belt. The main transmitting wheel 521 is connected to the engine 51, and the transmitted wheel 522 is connected to the two deceleration gear boxes 53 by one transmission shaft 54. The two deceleration gear boxes 53 are connected to the gear box 21 of each of the rotor sets 20 via the transmission shafts 54.

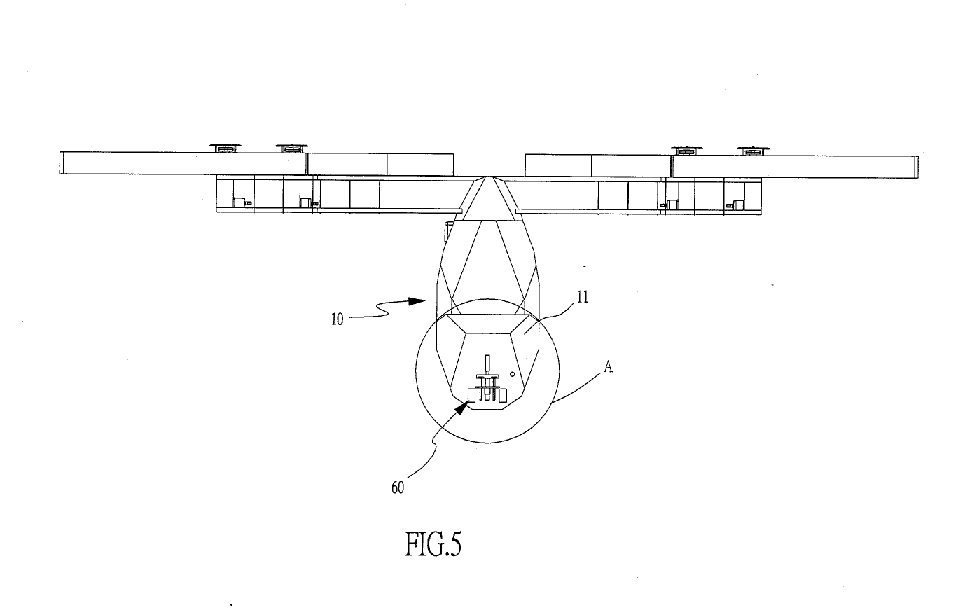

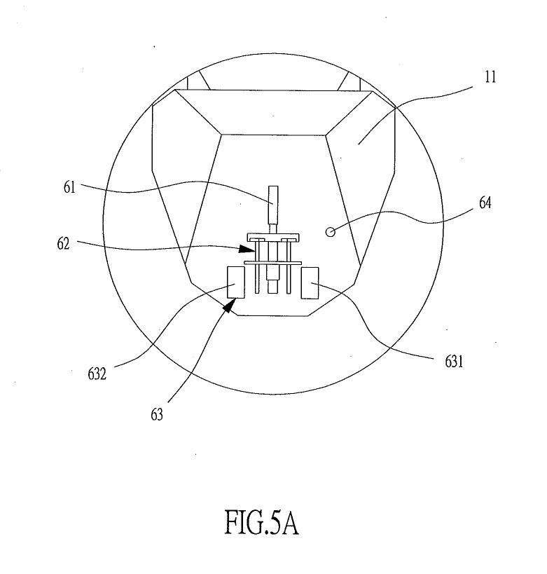

As shown in FIGS. 2, 5 and 5A, a control device 60 is provided at an interior of the front region 11 of the airframe 10. The control device 60 includes a control lever 61, a flight control system 62, a pair of pedals 63 and a force configuration lever 64. The control lever 61 is connected to the power angle control module 22 of each rotor set 20, and controls a difference in the power angle of each rotor set 20. The flight control system 62 collects and calculates various flight data, so as to drive the linear servo motor 23 of each rotor set 20 and to further independently control each rotor set 20. The pedals 63 include a left pedal 631 and a right pedal 632 that respectively control the difference between the power angles of each two diagonal rotor sets 20. More specifically, the diagonal rotor sets 20 refer to the front left rotor set 31 and the rear right rotor set 42 that are diagonal to each other, and the front right rotor set 32 and the rear left rotor set 41 that are diagonal to each other (as shown in FIG. 3). The force configuration lever 64 serves for simultaneously controlling the power angles of the four rotor sets 20.

The above flight control system 62 further includes numerous flight-associated sensors, e.g., a gyroscope for sensing posture conditions, a geomagnetic sensor (electronic compass) for sensing the current flight orientation, a triaxial acceleration sensor for sensing dynamic reactions of the helicopter, an altimeter for detecting the current altitude, an airspeed indicator for detecting the flight airspeed, a GPS (Global Positioning System) system for acquiring the current longitude and latitude, a radar for detecting distances between nearby obstacles and the ground, a fuel gauge, a meter throttle, an engine tachometer, etc. Sensing signals of these sensors are 16-bit digital signals, and are updated at a speed of approximately 100 times per second. As such, the flight control system collects the data of all the above sensors at a speed of hundreds of times per second.

Details of the flight control method of the present invention are given with reference to FIGS. 1 to 5 below. When the helicopter is to move forward or backward, the control lever 61 is operated for associated controls. When the control lever 61 is shifted forward, the two rotor sets 20 of the front rotor sets 30 are respectively thrust upward via the respective linear servo motors 23 to decrease the power angles of the two rotor sets 20 of the front rotor sets 30, whereas the two rotor sets 20 of the rear rotor sets 40 are thrust downward via the respective linear servo motors 23 to increase the power angles of the two rotor sets 20 of the rear rotor sets 40. As such, the buoyant force at the rear region 12 of the airframe 10 is increased in a way that the airframe 10 tilts forward and moves forward. In contrast, to move backward, the control lever 61 is shifted backward, the two rotor sets 20 of the front rotor sets 30 are respectively thrust downward via the respective linear servo motors 23 to increase the power angles of the two rotor sets 20 of the front rotor sets 30, whereas the two rotor sets 20 of the rear rotor sets 40 are thrust upward via the respective linear servo motors 23 to decrease the power angles of the two rotor sets 20 of the rear rotor sets 40. As such, the buoyant force at the front region 11 of the airframe 10 is increased in a way that the airframe 10 tilts backward and moves backward.

To move to the left or right, when the control lever 61 is shifted to the left, the front right rotor set 32 and the rear right rotor set 42 are thrust downward via the respective linear servo motors 23 to increase the power angles of the front right rotor set 32 and the rear right rotor set 42, whereas the front left rotor set 31 and the rear left rotor set 41 are thrust upward via the respective linear servo motors 23 to decrease the power angles of the front left rotor set 31 and the rear left rotor set 41. As such, the buoyant force at the right of the airframe 10 is increased in a way that the airframe 10 tilts to the left and moves to the left. When the control lever 61 is shifted to the right, the front left rotor set 31 and the rear left rotor set 41 are thrust downward via the respective linear servo motors 23 to increase the power angles of the front left rotor set 31 and the rear left rotor set 41, whereas the front right rotor set 32 and the rear right rotor set 42 are thrust upward via the respective linear servo motors 23 to decrease the power angles of the front right rotor set 32 and the rear right rotor set 42. As such, the buoyant force at the left of the airframe 10 is increased in a way that the airframe 10 tilts to the right and moves to the right.

The pedals 63 are utilized for controlling the rotating the direction of the helicopter. When the right pedal 632 is stepped, the front right rotor set 32 and the rear left rotor set 41 (counterclockwise rotors) are thrust downward via the respective linear servo motors 23, so that the power angles as well as torques of the front right rotor set 32 and the rear left rotor set 41 are increased. Meanwhile, the front left rotor set 31 and the rear right rotor set 42 are thrust upward via the respective linear servo motors 23, so that the power angles as well as the torques of the front left rotor set 31 and the rear right rotor set 42 are decreased. As such, the torques of the four rotor sets 20 caused to be unequal, i.e., the clockwise torque is greater than the counterclockwise torque, thereby rotating the airframe 10 to the left (rotating the airframe 10 clockwise).

When the left pedal 631 is stepped, the front left rotor set 31 and the rear right rotor set 42 (counterclockwise rotors) are thrust downward via the respective linear servo motors 23, so that the power angles as well as the torques of the front left rotor set 31 and the rear right rotor set 42 are increased. Meanwhile, the front right rotor set 32 and the rear left rotor set 41 are thrust upward via the respective linear servo motors 23, so that the power angles as well as the torques of the front right rotor set 32 and the rear left rotor set 41 are decreased. As such, the torques of the four rotor sets 20 are caused to be unequal, i.e., the counterclockwise torque is greater than the clockwise torque, thereby rotating the airframe 10 to the right (rotating the airframe 10 counterclockwise).

Ascending and descending of the helicopter are controlled by the force configuration lever 64. When the force configuration lever 64 is pulled upward, the power angles of the four rotor sets 20 are increased by the respective linear servo motors 23, so that the buoyant force is increased to lift the airframe 10. In contrast, to descend the helicopter, the force configuration lever 64 is pressed downward, and the power angles of the four rotor sets 20 are decreased by the respective linear servo motors 23, so that the buoyant force is reduced to sink the airframe 10.

As previously described, a windshield 25, serving for protection purposes, is encircled outside the rotation radius of each propeller 24 of the rotor sets 20. In addition to protecting the propellers 24, the windshields 25 also reduced influence that the flight airspeed poses between the rotor sets 20 to reduce the airspeed between and noise of the rotor sets 20. More importantly, the windshields 25 further lower risks of stalling of the rotor sets resulted by downwind when the helicopter is in a high-speed flight.

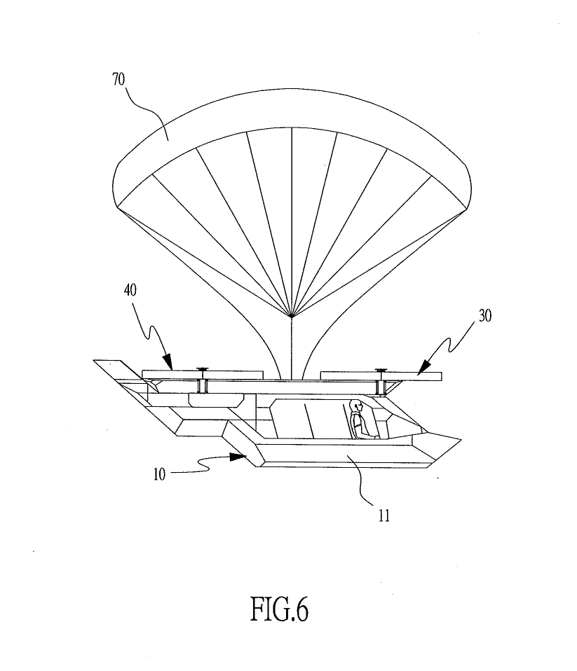

As shown in FIG. 6, in the present invention, a parachute 70 may be further installed to an upper part of the front region 11. When power loss occurs in the rotor sets, a pilot may activate the parachute 70 and utilize the parachute 70 to achieve an effect of a slow landing, thereby safely landing both the passenger and the helicopter. Since the distance between the pair of front rotor sets 30 is greater than that between the pair of rear rotor sets 40, instead of being influenced by the pair of front rotor sets 30 to undesirably affect operations of the parachute 70, the parachute 70 is ensured, to open up reliably.

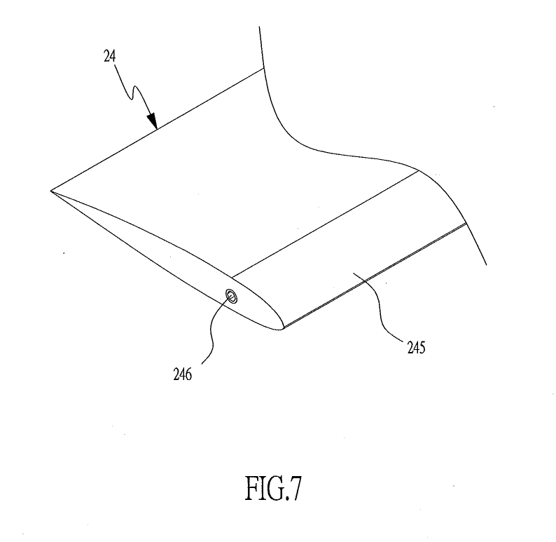

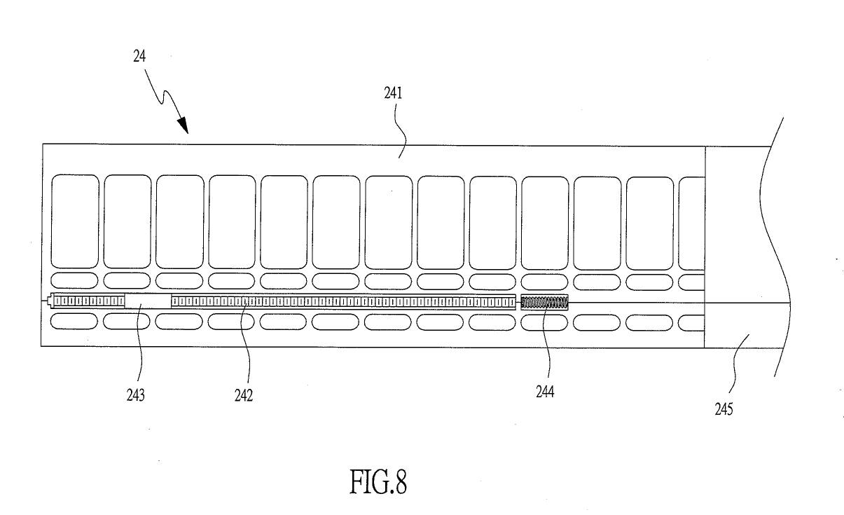

Referring to FIGS. 7 and 8, in the present invention, a weight proportion of each propeller 24 in the rotor sets 20 may be independently adjusted. In the embodiment, each propeller 24 includes a body 241, an adjustment screw 242, a weight block 243, an elastic element 244 and a cladding layer 245. The adjustment screw 242 is disposed at an interior of the body 241, and has one end formed as an adjustment portion 246 extending to an exterior of the body 241 and the other end accommodated in the elastic element 244. The weight block 243 is screwed to the adjustment screw 242. The cladding layer 245 covers the exterior of the body 241 such that the adjustment portion 246 is revealed on the cladding layer 245.

To adjust the weight proportion of each propeller 24, a force is applied to the adjustment portion 246 at the exterior of the body 241, so that a force is applied to the elastic element 244 at the other end of the adjustment screw 242 to withdraw the adjustment portion 246 to the interior of the body 241. The adjustment portion 246 is then rotated to displace the weight block 243 on the adjustment screw 242. When the weight block 243 is adjusted to an appropriate position, the adjustment portion 246 is released, and is moved outward by the adjustment screw 242 due to an elastic restoration effect generated by the elastic element 244, until the adjustment portion 246 is revealed on the cladding layer 245. Thus, the adjustment and calibration for dynamic balance can be performed for propellers 24 through adjusting the respective weight blocks 243.

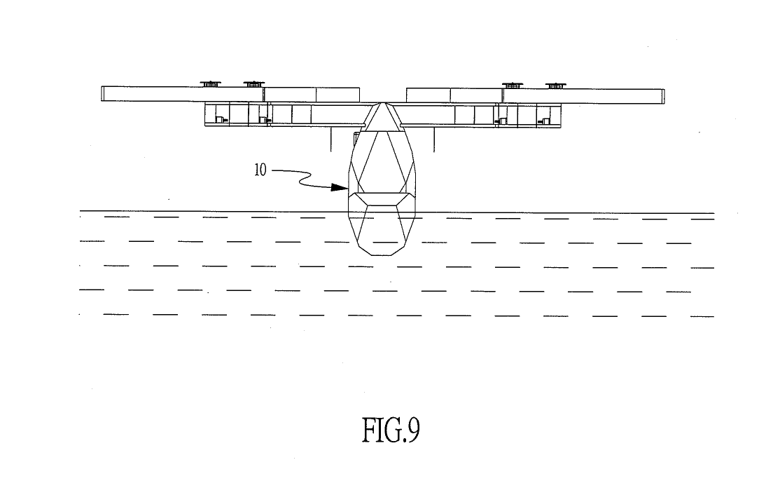

As shown in FIG. 9, the airframe 10 may be designed as a boat shape. When the helicopter lands on the sea due to a forced landing, the boat shape of the airframe 10 allows the airframe 10 to safely float on the sea to ensure the safety of passengers on the sea.

Compared to a conventional helicopter, the present invention offers the advantages below. First of all, total balance of aerodynamic forces at the left and right of the airframe is achieved to greatly mitigate flight complications and flight risks. As the torque generated by the engine is also balanced, the pilot is not required to adjust the direction of the helicopter when the torque changes, thereby reducing a burden of the pilot. Further, control operations for left and right tail rotors are eliminated, so that approximately 20% of the engine power can be saved to enhance fuel efficiency. The control system of the helicopter of the present invention is quite simple, and does not require the control method that is employed by a main rotor of a conventional helicopter. With sufficient space for installing an ejecting parachute, the parachute can be ejected in the event of an emergency to ensure the safety of passengers and the helicopter. Using the design of windshields for the four rotor sets, apart from enhancing the efficiency of the rotor sets, mutual influences among the four rotor sets are also reduced to significantly lower the noise of the rotor sets. Moreover, based on the above features, the airspeed of the helicopter can be increased.

While the invention has been described by way of example and in terms of the preferred embodiments, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A helicopter with an H-pattern structure, comprising:
an airframe, comprising a front region and a rear region;
a pair of front rotor sets, formed by two rotor sets, disposed at left and right sides of the front region of the airframe, respectively, being rotated in opposite directions;
a pair of rear rotor sets, formed by another two rotor sets, disposed at left and right sides of the rear region of the airframe, respectively, being rotated in opposite directions; and
a control device, disposed at an interior of the front region of the airframe, comprising:
a control lever, configured to control a flight direction and to generate a control signal; and
a flight control system, configured to calculate the control signal and to control the pair of front rotor sets and the pair of rear rotor sets.

2. The helicopter according to claim 1, wherein the airframe is a boat shape.

3. The helicopter according to claim 1, wherein each of the rotor sets comprises a gear box, a power angle control module, a linear servo motor and at least one propeller.

4. The helicopter according to claim 3, wherein each of the rotor set further comprises a windshield encircling outside a rotation radius of the propeller.

5. The helicopter according to claim 3, wherein each of the propellers is capable of independently adjusting a power angle thereof.

6. The helicopter according to claim 3, wherein each propeller of the rotor sets further comprises a body, an adjustment screw, a weight block, an elastic element and a cladding layer; the adjustment screw is disposed at an interior of the body, and has one end formed as an adjustment portion extending to an exterior of the body and one other end accommodated in the elastic element; the weight block is screwed to the adjustment screw; and the cladding layer covers the exterior of the body such that the adjustment portion is revealed on the cladding layer.

7. A helicopter with an H-pattern structure, comprising:
an airframe, comprising a front region and a rear region;
a pair of front rotor sets, formed by two rotor sets, disposed at left and right sides of the front region of the airframe, respectively, being rotated in opposite directions;
a pair of rear rotor sets, formed by another two rotor sets, disposed at left and right sides of the rear region of the airframe, respectively, being rotated in opposite directions;
an H-pattern transmission mechanism, disposed in the airframe, comprising an engine, a set of transmission mechanism, two deceleration gear boxes and a plurality of transmission shafts; the transmission mechanism comprising a main transmitting wheel and a transmitted wheel, the main transmitting wheel being connected to the engine, the transmitted wheel being connected to the deceleration gear boxes via one transmission shaft, and the two deceleration gear boxes being connected to the pair of front rotor sets and the pair of rear rotor sets, respectively; and
a control device, disposed at an interior of the front region of the airframe, comprising:
a control lever, configured to control a flight direction and to generate a control signal; and
a flight control system, configured to calculate the control signal and to control the pair of front rotor sets and the pair of rear rotor sets.

8. The helicopter according to claim 1, wherein a parachute is installed at an upper part of the front region of the airframe; a pilot ejects and opens the parachute when a machinery malfunction occurs, and the parachute lifts the entire helicopter and descends at a slow speed to prevent passenger casualties and helicopter damage; during a descending process of the parachute, the pilot is capable of manipulating cables of the parachute to control a flight altitude or direction to avoid falling on a hazardous area.

9. The helicopter according to claim 7, wherein a parachute is installed at an upper part of the front region of the airframe; a pilot ejects and opens the parachute when a machinery malfunction occurs, and the parachute lifts the entire helicopter and descends at a slow speed to prevent passenger casualties and helicopter damage; during a descending process of the parachute, the pilot is capable of manipulating cables of the parachute to control a flight altitude or direction to avoid falling on a hazardous area.
